(19) United States
(12) Patent Application Publication
(10) Pub. No.: US 2004/0147223 A1
(43) Pub. Date: Jul. 29, 2004

(54) System, apparatus and method for wireless mobile communications in association with mobile ad-hoc network support

(76) Inventor: Kwang Sun Cho, Gyeonggi-do (KR)

Correspondence Address: Merchant & Gould, PO Box 2903, Minneapolis, MN, 55402-0903, US

(21) Appl. No.: 10/472,170

(22) PCT Filed: Apr. 2, 2003
(86) PCT No.: PCT/KR03/00661

(30) Foreign Application Priority Data
Apr. 2, 2002 (KR) 10-2002-0018049

(51) Int. Cl. H04B 5/00; H04B 1/38; H04M 1/00

(52) U.S. Cl. 455/41.2; 455/553.1; 455/552.1

(57) ABSTRACT

The present invention generally relates to a mobile communication technology combining with AD-HOC, and more specifically, to a mobile communication system configured to include a fixed communication facility for controlling communication between mobile terminal devices such as a transmission mobile terminal device, a reception mobile terminal device and other non-participation mobile terminal devices, and for mediating communication between the transmission mobile terminal device and the reception mobile terminal device. An AD-HOC network is formed between the mobile terminal devices, each device including a second frequency communication means for direct communication. When the AD-HOC network is formed between the transmission mobile terminal device, the reception mobile terminal device and other non-participation mobile terminal devices via the second frequency communication means, the transmission mobile terminal device can communicate with the reception mobile node via the AD-HOC network. Accordingly, the disclosed wireless mobile communication system can be effectively operated with reduced communication cost.

### TECHNICAL FIELD

The present invention generally relates to a mobile communication technology combining with AD-HOC, and more specifically, to a mobile communication system configured to include a fixed communication facility, the system for communicating between devices via an AD-HOC network using a single or multi-hop when the same AD-HOC network is formed between a transmission mobile terminal device and a reception mobile terminal device.

### BACKGROUND ART

Various mobile communication service has been recently developed due to common use of wireless communication using mobile terminal devices such as a cellular phone, a PDA, a laptop. However, a plurality of networks per mobile communication service are formed overlapping each other in the same region, and each mobile communication service has different communication cost, data transmission capacity and connection condition. As a result, when a user uses a plurality of mobile communication service if necessary, the user should have an extra mobile terminal device appropriate to each mobile communication service and cannot connect with mobile communication service which is not supported by user's mobile terminal device. Although a terminal using a double band (for example, supporting CDMA and GSM, or CDMA and WLAN) is developed in order to the above-described problem, the terminal should be selectively used in a region providing a specific mobile communication service.

The kinds of mobile communication service are classified on the basis of coverage of wireless communication range as follows. First, a global layer is mobile communication service having a wireless communication range of more than 100 km, such as satellite communication which enables distant communication between areas, countries or continents. Second, a macro layer as a lower layer has the cellular system having a wireless communication range of about 3 km such as CDMA (Code Division Multiple Access), GSM (Global System for Mobile Communication), IMT-2000, W-CDMA, DVB (Digital Video Broadcasting) and DAB (Digital Audio Broadcasting), the wireless data transmission system having a wireless communication range of 2˜5 km such as LMDS (Local Multi-point Distribution Service), or the wireless data transmission system having a wireless communication range of about 30 km such as MMDS (Multi-point Multi-channel Distribution Service). Next, a micro layer has a wireless communication range of about 300 m such as WLAN (Wireless LAN) and HIPERLAN (High Performance Radio LAN). Finally, a pico layer as the least significant layer has a wireless communication range within 10 m such as Bluetooth as WPAN (Wireless Personal Area Network), UWB (Ultra Wide-Band) or Wireless IEEE 1394.

Most mobile communication service has a system using a fixed communication facility and network based on a single hop. However, an AD-HOC network formed of a plurality of mobile terminal devices is a communication method to self-form, self-maintain and self-manage a network for providing a single hop or multi-hop without using a fixed communication facility and network.

FIG. 1 is a conceptual diagram illustrating an AD-HOC network system. A transmission mobile terminal device 30 and a reception mobile terminal device 40 communicate each other using a single hop or multi-hop method wherein non-participation mobile terminal devices 32, 34, 36 and 38 route data. The non-participation mobile terminal devices do not participate directly in intermediate communication. Each mobile terminal device 30, 32, 34, 36, 38 and 40 reconstructs an AD-HOC network depending on variations in location of mobile terminal devices and on addition or removal of mobile terminal devices by exchanging routing information at any time. As a result, the mobile terminal devices can cope actively with changeable communication condition, secure stable communication by performing communication via other routing path when some mobile terminal devices perform mis-operation. Additionally, since the AD-HOC network does not communicate using a fixed communication facility, a communication network can be constructed with low cost. Due to these advantages, the AD-HOC network is used for military communication, emergency communication and small computer network.

FIG. 2 is a diagram illustrating a conventional wireless mobile communication network. The conventional mobile communication network performs communication via a fixed network infrastructure comprising a plurality of base stations 22, 24 and 26, base station antennas formed in each base station, a base station controller BSC, a PCs exchanger PCX for controlling a plurality of base stations and a mobile switching center 20 MSC including a home location register HLR for grasping location of subscribers.

The communication between subscribers is as follows. A transmission subscriber terminal 12 sets communication with a first base station to which it belongs (102). A mobile communication exchange station 20 grasps location of a reception subscriber terminal 14 registered in HLR to connect with a second base station 26 to which the reception subscriber terminal 14 belongs via a wire network (106). The second base station 26 finally sets communication with the reception subscriber terminal 14 (108). In other words, the process of setting communication of the conventional wireless communication system is performed by control and mediation of the mobile communication exchange station 20 which is a fixed communication facility.

When communication is performed using a fixed communication facility, the following problems occur.

First, a mobile communication of great capacity and a plurality of base stations 22, 24 and 26 are required to provide wide area communication service. As a result, a subscriber bears high communication service fee due to facility investment cost and facility management cost. Particularly, since a fixed communication facility is used in all communications, a reception subscriber and a transmission subscriber should bear the same user's fees regardless of distance even when they are within a short distance.

Second, since all communications are performed by control and mediation of fixed communication facilities, a subscriber cannot receive communication service when the subscriber is out of a range of a base station.

Third, since fixed communication facilities having different systems are used by service providers, a subscriber cannot receive communication service when the subscriber is out of a range of the service provider. For example, a subscriber using a CDMA terminal cannot receive communication service via his/her terminal in a country using a GSM system.

Fourth, according to current mobile communication technology, in the above various mobile communication networks, a horizontal hand-off system is admitted for supporting seamless communication during movement between base stations or access points (hereinafter, referred to as ‘connection node’) of the same mobile communication networks depending on geographical movement. For example, when a wireless LAN user moves, a connection node which the user currently connects with hands off a traffic of the wireless LAN user into a new connection node if there is other connection nodes adjacent to the wireless LAN. However, when there is no connection nodes in a new region, the communication of the wireless LAN user is stopped. Particularly, since the micro layer such as wireless LAN has a short wireless communication range, the number of connection nodes are considerably required in the micro layer than in the macro layer. As a result, a wireless LAN region of the user may be limited unless many connection nodes are installed. When a wireless LAN user uses cellular service as well as wireless LAN service, a vertical hand-off into cellular service is not supported during use of wireless LAN service even in a region having no connection node for the wireless LAN but having a connection node for cellular service.

### DETAILED DESCRIPTION OF THE INVENTION

In order to overcome the above-described problems, the present invention has an object to provide a communication system, a communication method and a mobile terminal device appropriate to the system and method which may provide both a function of the conventional mobile terminal device and a mediating function of a fixed communication facility by using a mobile terminal device for self-forming an AD-HOC network.

A preferred embodiment of the present invention has an object to provide a communication system which may receive communication service by using the fixed communication facility even when a mobile terminal device is out of a service providing range of the fixed communication facility, a communication method and a mobile terminal device appropriate to the system and method.

Another preferred embodiment of the present invention has an object to provide a communication system which may receive communication service by using the fixed communication facility even in a service providing range of the fixed communication facility for providing different communication services, a communication method and a mobile terminal device appropriate to the system and method.

Still another preferred embodiment of the present invention has an object to provide a communication system which can change a communication mode actively according to communication condition when mobile terminal devices communicate via an AD-HOC network, a communication method and a mobile terminal device appropriate to the system and method.

Still another preferred embodiment of the present invention has an object to provide a communication system wherein a vertical hand-off is possible between different wireless mobile communication networks using the common AD-HOC protocol, a communication method, and a mobile terminal device appropriate to the system and method.

Still another preferred embodiment of the present invention has an object to provide a communication system which can connect with a satellite ground station for communication with a satellite or VSAT, a micro bidirectional satellite terminal device, a communication method, and a mobile terminal device appropriate to the system and method.

Still another preferred embodiment of the present invention has an object to provide a communication system wherein data can be effectively routed between different mobile communication networks by extracting precise location information of a mobile terminal device from a GPS communication signal or a beacon signal received from an adjacent mobile terminal device, a communication method, and a mobile terminal device appropriate to the system and method.

In order to achieve the above-described objects, there is provided AD-HOC combined mobile communication system configured to include a transmission mobile terminal device, a reception mobile terminal device and other non-participation mobile terminal devices and a fixed communication facility for controlling communication between mobile terminal devices and for mediating communication between the transmission mobile terminal device and the reception mobile terminal device, wherein an AD-HOC network is formed between the mobile terminal devices, each device including a second frequency communication means for direct communication; wherein the transmission mobile terminal device can communicate with the reception mobile terminal device via the AD-HOC network when the AD-HOC network is formed between the transmission mobile terminal device, the reception mobile terminal device and other non-participation mobile terminal devices via the second frequency communication means for intercommunication.

There is also provided an AD-HOC combined mobile communication device configured to be controlled by a fixed communication facility and communicate with other mobile terminal device via the fixed communication facility, comprising: a first frequency communication means for communication via the fixed communication facility; a second frequency communication means for transmitting and receiving data, a beacon signal and routing information into other mobile terminal devices via an AD-HOC network; and a processor for controlling the communication device, wherein the processor includes: a beacon processing unit for detecting other mobile terminal device within a range of the second frequency for formation of the AD-HOC network; a routing processing unit for generating its routing table dependent on detection results from the beacon processing unit and routing information received from other mobile terminal devices; and a communication processing unit for activating the second frequency communication means when other mobile terminal devices for communication are included in the routing table, and for activating the first frequency communication means when they are not included in the routing table.

There is also provided an AD-HOC combined mobile communication method for performing communication between mobile terminal devices controlled by a fixed communication facility via a first frequency, comprising: a first step wherein the mobile terminal device grasps other mobile terminal devices within a range of a second frequency; a second step wherein routing information is consecutively exchanged between the mobile terminal devices to generate a routing table, thereby forming an AD-HOC network; and a third step wherein a transmission mobile terminal device communicates with the target mobile terminal device via the AD-HOC network for forming a non-participation mobile terminal device using the second frequency when a reception mobile terminal device wanting for communication exists in the routing table, and via the fixed communication facility using the first frequency when the reception mobile terminal device does not exist in the routing table.

There is also provided an AD-HOC combined mobile terminal device configured to connect selectively with at least two or more of a plurality of communication networks and communicate with other mobile terminal device via the communication network, comprising: a beacon processing unit for detecting other mobile terminal device within a range of the second frequency for formation of the AD-HOC network; a routing processing unit for generating its routing table dependent on detection results from the beacon processing unit and routing information received from other mobile terminal devices or connection nodes to transmit the routing table into the other mobile terminal devices or the connection nodes at any time; a data processing unit for generating and processing data dependent on an AD-HOC protocol including the routing information; a communication network determining unit for grasping a usable network dependent on the routing table and determining a network to be used; and a communication unit for supporting communication with at least two or more of a plurality of different networks and AD-HOC communication with other mobile terminal devices.

There is also provided an AD-HOC combined mobile terminal device including a plurality of data link layers and physical layers which are connectable with one or more networks, comprising a MAC control sub-layer for selecting one of the plurality of data link layers and physical layers, including a MAC control header dependent on an AD-HOC communication protocol in a communication packet transmitted from an upper layer, and mediating communication packets received according to the AD-HOC protocol from other mobile terminal devices.

There is also provided an AD-HOC combined mobile communication system, comprising: at least two or more of a plurality of networks for connecting with mobile terminal devices via connection nodes, mediating sound and data communication of mobile terminal devices and routing data according to an AD-HOC protocol; and a mobile terminal device for directly connecting with connection nodes of at least two or more of the networks and other mobile terminal devices to transmit or receive sound or data, selectively connecting with other mobile terminal devices or one of connection nodes of the networks according to communication protocols corresponding to each network during communication dependent on communication condition, and broadcasting its routing information to other mobile terminal devices and the connection nodes by updating a routing table related to other mobile terminal devices or the connection nodes connected at any time according to the AD-HOC protocol, wherein when the connected mobile terminal device connects with a second network from a first network currently communicated of the plurality of networks, the first network routes the sound and data communication of the mobile terminal device into the second network.

There is also provided an AD-HOC combined mobile communication method, comprising: a first step of detecting a connectable network and an adjacent mobile terminal device to generate a routing table and determine a network to be connected; a second step of adding a MAC-control header according to an AD-HOC protocol in a sound and data packet to be transmitted; a third step of connecting with the network via a physical layer connectable with the network determined in the first step, and connecting with other mobile terminal devices directly connectable with other adjacent mobile terminal devices when a mobile terminal device does not have a connectable network; a fourth step of continuously monitoring connection condition with the network connected in the third step or other mobile terminal devices, and renewing a routing table; and a fifth step of connecting other networks or other mobile terminal devices except the currently connected network or other mobile terminal network when the connection condition is proved to be inferior.

### BRIEF DESCRIPTION OF THE DRAWINGS

FIG. 1 is a conceptual diagram illustrating an AD-HOC network.

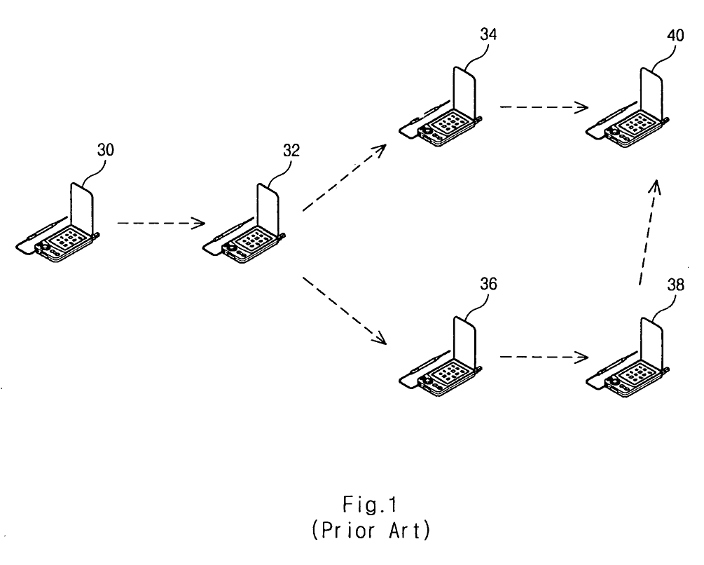

FIG. 2 is a diagram illustrating a conventional mobile communication system.

FIG. 3 is a diagram illustrating an AD-HOC combined communication system according to a preferred embodiment of the present invention.

FIG. 4 is a diagram illustrating an AD-HOC combined mobile terminal device according to a preferred embodiment of the present invention.

FIG. 5 is a diagram illustrating layer charts of each mobile terminal device according to a preferred embodiment of the present invention.

FIG. 6 is a flow chart illustrating an AD-HOC communication method between a transmission mobile terminal device and a base station according to a preferred embodiment of the present invention.

FIG. 7 is a flow chart illustrating an AD-HOC communication method between a base station and a reception mobile terminal device according to a preferred embodiment of the present invention.

FIG. 8 is a flow chart illustrating a method for detecting a mobile terminal device and exchanging routing information according to a preferred embodiment of the present invention.

FIG. 9 is a flow chart illustrating an AD-HOC communication mode converting method according to a preferred embodiment of the present invention.

FIG. 10 is a diagram illustrating an AD-HOC combined mobile communication network according to a preferred embodiment of the present invention.

FIG. 11 is a diagram illustrating a structure of an AD-HOC combined mobile terminal device according to another preferred embodiment of the present invention.

FIG. 12 is a diagram illustrating communication layers of an AD-HOC combined mobile terminal device according to another preferred embodiment of the present invention.

FIG. 13 is a flow chart illustrating a data packet processing method of a MAC control sub-layer of an AD-HOC combined mobile terminal device according to a preferred embodiment of the present invention.

FIG. 14 is a diagram illustrating a packet structure of a MAC control header of an AD-HOC combined mobile terminal device according to a preferred embodiment of the present invention.

FIG. 15 is a diagram illustrating a structure of an AD-HOC combined mobile communication system according to a preferred embodiment of the present invention.

FIG. 16 is a flow chart illustrating a communication method of an AD-HOC combined mobile terminal device according to another preferred embodiment of the present invention.

### PREFERRED EMBODIMENTS

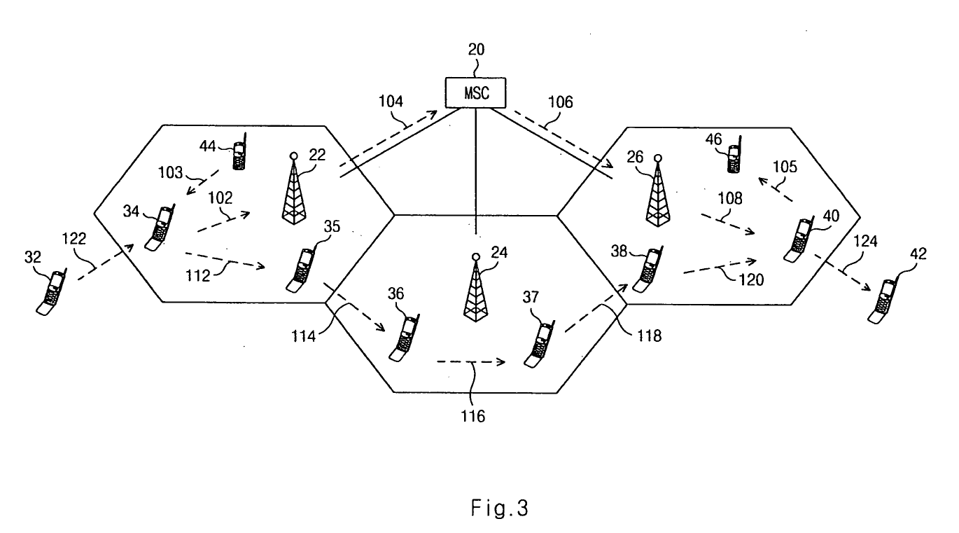

FIG. 3 is a diagram illustrating an AD-HOC combined communication system according to a preferred embodiment of the present invention. The AD-HOC combined communication system comprises fixed communication facilities 20, 22, 24 and 26 identical with conventional fixed communication facilities such as CDMA, TDMA, GSM, GPRS and IMT2000, and mobile terminal devices 32, 34, 35, 36, 37, 38, 40, 42, 44 and 46 which can self-form an AD-HOC network.

Each mobile terminal device includes a second frequency communication means for direct communication by forming an AD-HOC network with other mobile terminal devices. Hereinafter, a first frequency communication refers to wireless communication using fixed communication facilities, and a frequency used herein is a first frequency. A second frequency communication refers to an AD-HOC communication, and a frequency used herein is a second frequency.

Preferably, the second frequency is a licensed or unlicensed usable frequency such as ISM (industrial scientific and medical) frequency of 2.4 GHz or U-NII (unlicensed national information infrastructure) frequency of 5 GHz. The unlicensed frequency refers to a frequency band used freely without extra license of wireless communication. The ISM frequency band is an unlicensed band for industry, science and medical care using weak field strength. The U-NII frequency band is a freely used frequency which belongs to the U.S. unlicensed national information infrastructure for using wireless LAN.

When a transmission mobile terminal device 34 and a reception mobile terminal device 40 are formed in the same AD-HOC network, the transmission mobile terminal device 34 transmits data into the reception mobile terminal device 40 via mediating mobile terminal devices 35, 36, 37 and 38 which do not participate in communication by using multi-hops 112, 114, 116, 118 and 120. Here, data need not be sound data, and the data can include all types of data such as video data, message data and multimedia data which can be packeted and transmitted.

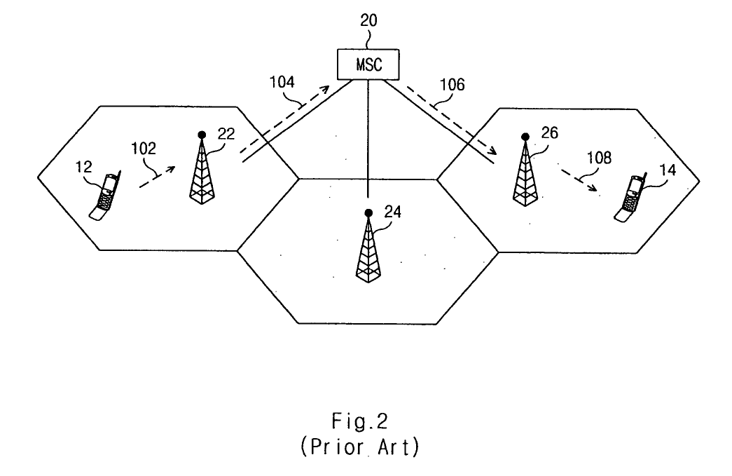

When the transmission mobile terminal device 34 and the reception mobile terminal device 40 are not included in the same AD-HOC network, the mobile terminal devices can communicate via fixed communication facilities 20, 22 and 26 like the conventional communication system as shown in FIG. 2.

The transmission mobile terminal device 34 may not be connected to the reception mobile terminal device 40 via the AD-HOC network and fixed communication facilities. Here, it is preferable that a first AD-HOC network can be connected to a second AD-HOC network via a fixed communication facility when the transmission mobile terminal device 34 and the reception mobile terminal device 40 are included in a first AD-HOC network and a second AD-HOC network, respectively. The advantage of the above-described communication system is represented when at least one of the transmission mobile terminal device 34 and the reception mobile terminal device 40 is out of a range of communication service or does not use a communication system supported by fixed communication facilities.

A case is exemplified when the transmission mobile terminal device 44 uses a CDMA system, and fixed facilities and the reception mobile terminal device 40 use a GSM system. When the transmission mobile terminal device 44 and the reception mobile terminal device 40 are formed in the same AD-HOC network, the transmission mobile terminal device 44 can communicate with the reception mobile terminal device 40 via the mediating mobile terminal devices 34, 35, 36, 37 and 38 using the second frequency. However, when they are not formed in the same AD-HOC network, the transmission mobile device 44 is connected with the mobile terminal device 34 using the GSM system among different mobile terminal devices 34 and 35 formed in the same AD-HOC network via the second frequency communication (103). The mobile terminal device 34 routes data into the base station 22 via the first frequency communication (GSM) (102). The mobile communication exchange station 20 transmits data from the base station 22 into the base station 26 where the reception mobile terminal device 40 (104, 106). The base stations transmit data into the reception mobile terminal device 40 via the first frequency communication GSM (108), thereby setting communication.

Next, when the transmission mobile terminal device 32 is out of a range of a first frequency communication service area, the same communication procedure is performed as described above except connection to the mediating mobile terminal device 34, which can connect with the base station 22, via the second frequency communication (122).

The similar communication procedure is performed when the reception mobile terminal device 46 uses a different communication system from the transmission mobile terminal device 34 and fixed communication facilities. Since the transmission mobile terminal device 34 does not connect with the reception mobile terminal device 46 via the second frequency communication, it is connected with the base station 22 via the first frequency communication 102. The mobile communication exchange station 20 transmits data from the base station 22 into the base station 26 where the mediating mobile terminal device 40 is formed in the same AD-HOC network including the reception mobile terminal device 40 and uses the same first frequency communication system (104, 106). The base station 26 transmits data into the mediating mobile terminal device 40 via the first frequency communication (108). The mediating mobile terminal device 40 transmits data into the reception mobile terminal device via the second frequency communication (105), thereby performing communication.

When the reception mobile terminal device 42 is out of the first frequency communication service area, the same communication procedure is performed as described above except connection to the reception mobile terminal device 42 via the second frequency communication of the mediating mobile terminal device 40 in the base station 26 (124).

As shown in the cases when the transmission mobile terminal device and the reception mobile terminal device use different communication systems, and the reception mobile terminal device is out of the service area, the above-described four cases can be preferably combined. More preferably, each base station 22, 24 and 26 can forms the AD-HOC network with mobile terminal devices by further comprising the second frequency communication means or receive routing information of mobile terminal devices within a cell via the second frequency communication.

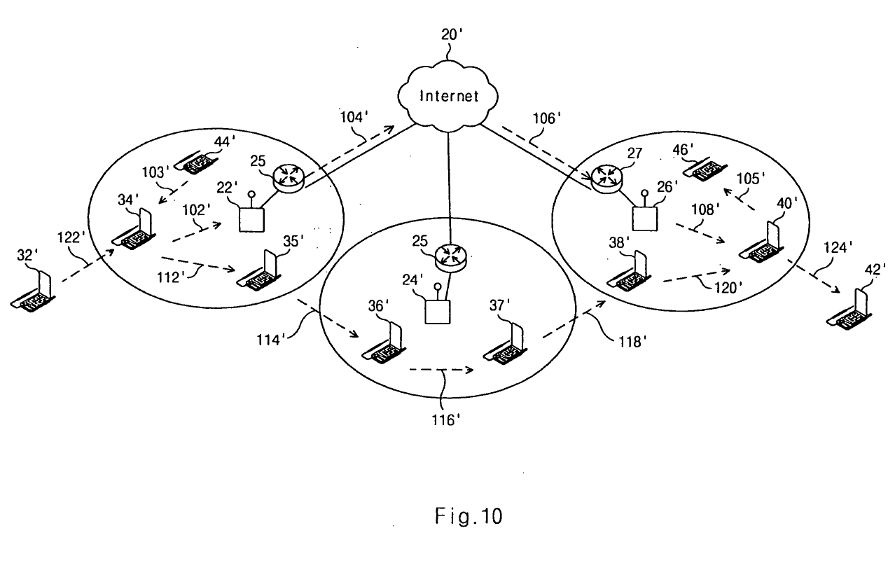

The present invention can be applied to wireless data communication service such as Bluetooth, wireless ATM or wireless LAN as well as mobile phone service such as cellular service or PCS service. FIG. 10 shows an example using wireless data communication. In the example using wireless data communication, the system structure and the operation process between system components are the same with the example using mobile phone service of FIG. 3, but the structure of fixed communication facilities is different. The fixed communication facilities of the wireless data communication service are formed of a plurality of access points 22′, 24′ and 26′ covering a certain area, routers 23, 25 and 27, and a computer network 20′ such as Internet. The computer network 20′ is connected with each router 23, 25 and 27 via coaxial lines or optical cable. The access point 22′, 24′ and 26′ correspond to networks connected by the base stations 22, 24 and 26 of FIG. 3, respectively. The routers 23, 25 and 27 correspond to networks connected by base station controllers (not shown in FIG. 3), respectively. The computer network 20′ corresponds to a network connected by the mobile communication exchange station 20. The explanation of FIG. 10 will be applied in that of FIG. 3 because the operation of the wireless data communication service is the same with that of the mobile communication service.

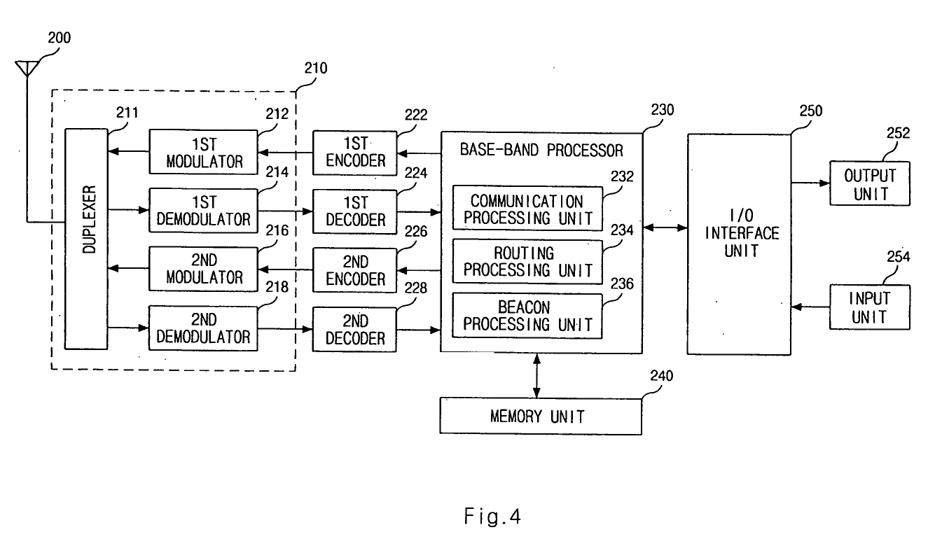

FIG. 4 is a diagram illustrating an AD-HOC combined mobile terminal device according to a preferred embodiment of the present invention. The mobile terminal device comprises an antenna 200, a frequency synthesizing unit 210, encoder/decoder 222, 224, 226 and 228, a base-band processor 230, an I/O interface unit 250, an output unit 252, an input unit 254 and a memory unit 240. A mobile terminal device according to the present invention comprises a second modulator 216 and a second demodulator 218 for a second frequency communication, a second encoder 226 and a second decoder 228, and a base-band processor 230 including a routing processing unit 234 and a beacon processing unit 236, unlike the conventional mobile terminal device.

Since a frequency used in an AD-HOC communication is different from that for common mobile communication, the frequency synthesizing unit 210 further includes the second modulator 216 and the second demodulator 218. The AD-HOC communication may include the encoder 226 and the decoder 228 different from a encoder 222 and a decoder 224 for a first frequency communication in order to obtain generality irrespective of communication systems by service or communication options by countries.

The base-band processor further includes the routing processing unit 234 and the beacon processing unit 236 except functions provided in the conventional mobile terminal device. The beacon processing unit 236 detects the existence of other mobile terminal devices within a range of a second frequency for forming the AD-HOC network. The routing processing unit 234 generates and maintains a routing table including the shortest and the optimum path according to detection results from the beacon processing unit 236 and routing information received from other mobile terminal devices. The communication processing unit 232 activates the second frequency communication means 216 and 218 when routing information of other mobile terminal devices wanting communication is included in its routing table, and activates the first frequency communication means 212 and 214 when it is not included in its routing table. However, the beacon processing unit 236, the routing processing unit 234 and the communication processing unit 232 are divided by functions. The actual functions may be performed simultaneously in a processor embodied into a chip or in parallel in a plurality of processors formed of separate chips.

Preferably, when mobile terminal devices cannot communicate directly with fixed communication facilities 20, 22, 24 and 26 via the first frequency communication means 212 and 214, the communication processing unit 232 includes routing control information in transmission data so as to be routed into other mobile terminal devices, which can communicate directly with the fixed communication facilities 20, 22, 24 and 26, via the second frequency communication means 216 and 218.

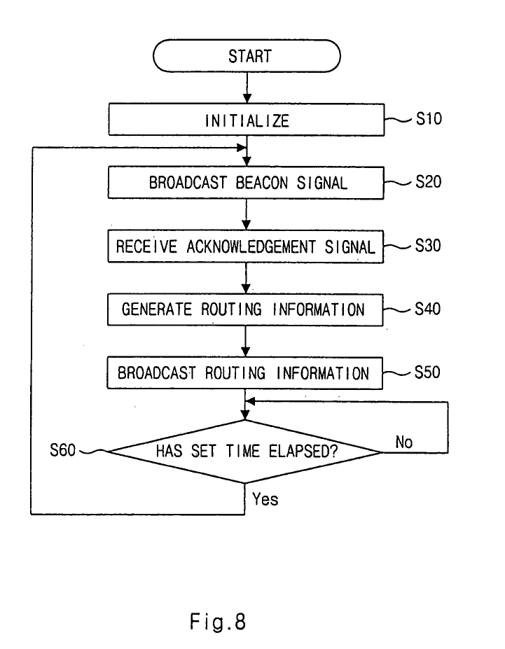

Referring to FIG. 8, the process of generating a routing table is explained. The beacon processing unit 236 periodically (S60) broadcasts a beacon signal to other mobile terminal devices via the second frequency communication means 216 and 218 (S20). The beacon processing unit 236 receives an acknowledgement signal of other mobile terminal device in response to the beacon signal (S30) to transmit the acknowledgement signal into the routing processing unit 234. The routing processing unit 234 combines the acknowledgement signal received from the beacon processing unit 236 and routing information received from other mobile terminal device to generate a routing table (S40). Then, the routing processing unit 234 broadcasts its routing information into other mobile terminal device based on the routing table (S50).

Preferably, the routing table may include a mobile terminal device identifier to other mobile terminal devices, the number of hops, the amount of power dissipation and location information. Here, the present invention further includes the power dissipation and location information as well as the information on the identifier and the number of hops included in a routing table used for general computer network. Since the use time of mobile terminal devices is limited by the characteristic of using battery, when a mobile terminal device having much consumed electric power is used as a mediating mobile terminal device, communication can be unstable due to power consumption of the mobile terminal device in a short time. As a result, the amount of power dissipation and location information should be considered as parameter in the routing algorithm.

The mobile terminal device identifier may be more than two mapping information among a phone number given to the mobile terminal device (or an electronic serial number given to the mobile terminal device), a MAC address, an IPv4 address and an IPv6 address. When a phone number is used for mapping information, the use of service is limited by different phone number system of each country. However, when a specific MAC address and an IP address are used, compatibility can be secured regardless of communication systems between countries.

Preferably, in order to select an appropriate communication mode according to the amount of communication in wireless data communication using the second frequency, the communication processing unit 232 checks the amount of transmitted and received data traffic, the competitive rate for channel between each mobile terminal device for occupying the second frequency, and the number of adjacent mobile terminal devices communicatable within a range of the second frequency at any time. Here, each mobile terminal device communicates via a centralized control communication mode when one of the individual information is proved to be more than set value, and via a distributed control communication mode when proved to be less than set value.

The data communication is divided into distributed control mode or contention mode, and the centralized mode or allocation mode. The distributed control communication mode such as ALOHA or CSMA (Carrier Sense Multiple Access) determines a packet connectable with a channel using a direct competitive system, and solves a collision problem via a random re-transmission system. The distributed control mode has a simple protocol, and uses a channel effectively without packet delay when a traffic load is low. However, as the traffic load of the channel increases, collisions frequently occur, and performance is considerably degraded due to exponential increase of packet delay.

The centralized control communication mode is one of slotted ALOHA, reservation ALOHA, PRMA (Packet Reservation Multiple Access), TDMA (Time division Multiple Access), reservation TDMA, polling, ISMA (Inhibit Sense Multiple Access) or Bluetooth. The centralized control mode as a communication model using a scheduling algorithm provides a communication synchronized using a method of allotting time slots to each node by reservation or polling. The centralized control mode can prevent collisions between packets because it allots time slots to each node, and perform a stable communication when an excessive traffic load is given to a channel. However, when the traffic load is small, since the centralized control mode has non-used slots inevitably generated from the communication, and packet delay resulting from the treatment of the slots, it is less effective than the distributed control mode.

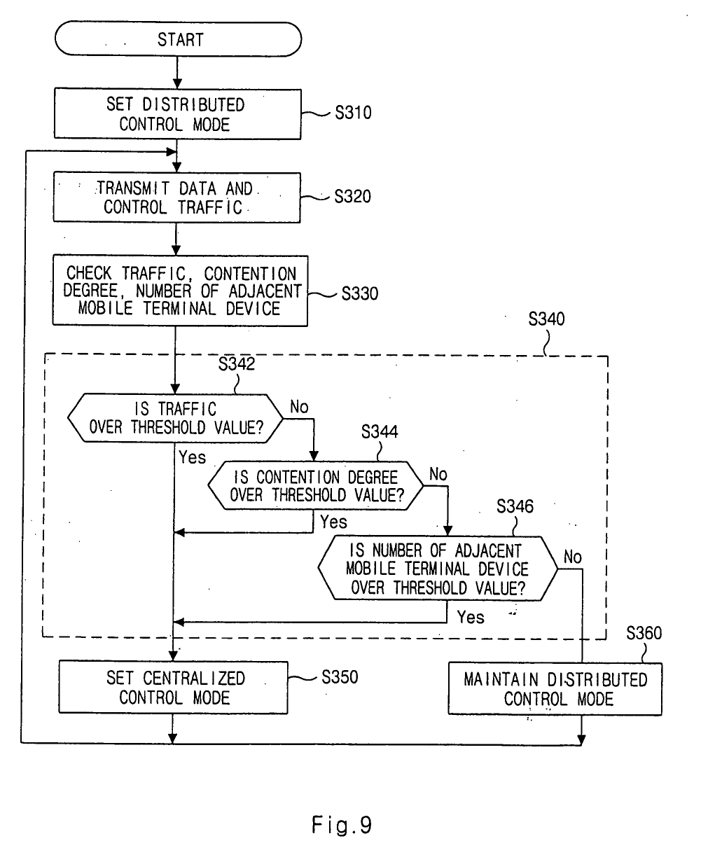

According to a preferred embodiment of the present invention, the second frequency communication between mobile terminal devices is performed by using the distributed control mode when the traffic load is small, and by using the centralized control mode when the traffic load is large, thereby maximizing efficiency of channel use. FIG. 9 shows a flow chart illustrating a communication mode converting process according to a preferred embodiment of the present invention. First, if a mobile terminal device is activated, the second frequency communication is performed (S320) basically using the distributed control mode (S310). Here, the centralized control mode may be used for an initial mode. Next, the mobile terminal device checks communication conditions including individual information such as traffic between other mobile terminal devices with which it communicates, the competitive rate for channel occupation in order that each mobile terminal device transmit and receive packets on a single channel using the second frequency, and the number of adjacent mobile terminal devices connectable via the second frequency communication at any time or periodically (S330). Then, the mobile terminal device determines whether the current communication condition is more appropriate to the centralized control mode or to the distributed control mode according to the checked condition information (S340). For example, the communication condition is determined using individual judgment conditions such as a case when the traffic is proved to be more than a set value (S342), a case when the competitive rate is proved to be more than a set value (S344) or a case when the connection node is proved to be more than a set value (S346). As a result, when the centralized control mode is appropriate, the centralized control mode is converted (S350), and when it is not appropriate, the distributed control mode is maintained (S360), thereby performing the second frequency communication (S320).

However, when the mobile terminal device communicates via the centralized control mode, a reference mobile terminal device for allotting time slots to each mobile terminal device should be decided like a client/server system. The reference mobile terminal device should be at least one or more in the same AD-HOC network. The reference mobile terminal device is selected from the group consisting of a mobile terminal device having the best power condition, a mobile terminal device having little variation in location and a mobile terminal device including the most mobile terminal devices within a range of the second frequency. A leader mobile terminal device is designated from the clustered mobile terminal devices using at least one judgment method.

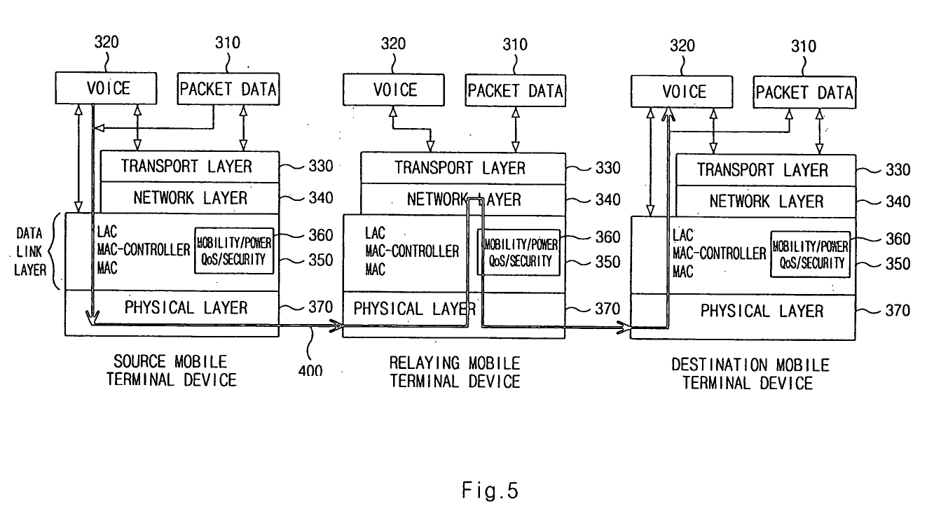

FIG. 5 is a diagram illustrating the layer structure of protocol according to a preferred embodiment of the present invention.

The protocol is formed of application layers 310 and 320, a transmission layer 330, a network layer 340, a link layer 350 and a physical layer 370. The protocol of the present invention further includes a mobility/power/QoS/security management module 360 in the network layer 340 and the link layer 350.

The application layers include a program for supporting a data communication 310 or a sound communication 320. The transmission layer 330 provides protocols such as TCP (Transmission Control Protocol) and UDP (User Datagram Protocol) supported in Internet in order to set a point-to-point communication. Here, QoS (Quality of Service) or a protocol for controlling flow and confusion is also provided in the transmission layer 330.

The network layer 340 provides a protocol for routing packet data between reception and transmission mobile terminal devices via a non-participation mobile terminal device. The link layer 350 provides a protocol for designating a reliable transmission and QoS according to demand of upper layers, and includes LAC (Link Access Control), MAC (Media Access Control), a MAC control sub-layer, and a mobile/power/QoS/security management module. The LAC is a sub-layer for managing one-to-one communication or one-to-multiple communication between upper layer. The MAC is a sub-layer which provides a protocol for managing service such as access support to a communication medium to reliably transmit and receive various kinds of data, multiplexing and de-multiplexing of different data streams, compensation of transmission error frames and synchronization. The MAC control sub-layer is used to designate the MAC layer and the physical layer appropriately according to the first frequency communication using fixed communication facilities or the second frequency communication using the AD-HOC network. The mobile/power/QoS/security management module 360 is used to manage various parameters necessary for routing and mapping information such as the above-described phone number (or a specific electronic serial number given to a corresponding mobile terminal device), an MAC address and IP address. The physical layer 400 is a protocol for coding, modulating and encoding data transmitted from the upper layers into a type appropriate to communication.

When the second frequency communication is performed via the AD-HOC network, data of the application layers 310 and 320 in the transmission mobile terminal device is transmitted through the transmission layer 330, the network layer 340, the link layer 350 and the physical layer 370 into a mediating mobile terminal device (400). Since the mediating mobile terminal device serves as a router for mediating data, when a packet for mediation is inputted, the packet is transmitted into the reception mobile terminal device, passing through the physical layer and the link layer into the mobile/power/QoS/security management module and the network layer without passing through the transmission layer or the application layer. The reception mobile terminal device transmits reception data into the application layer because it uses received data unlike the mediating mobile terminal device. Although a case when one mediating mobile terminal device is interposed is exemplified for convenience, the same procedure of communication is performed when more than two mediating mobile terminal devices are interposed between the transmission mobile terminal device and the reception mobile terminal device.

The communication process of the present invention wherein communication between mobile terminal devices controlled by fixed communication facilities via a first frequency is performed is as follows. In the first step, a mobile terminal device grasps other mobile terminal devices within a range of a second frequency. The method of grasping mobile terminal devices is performed by a method of broadcasting a beacon signal and replying an acknowledgement signal, as described above.

In the second step, routing information is consecutively exchanged between the mobile terminal devices to generate a routing table, thereby forming an AD-HOC network. Although the routing method is similar to that of conventional computer network, after the characteristic of mobile terminal devices using limited power source such as battery as described above is considered, it is preferable that information on power and location is included in the routing table, and then routing is performed via a routing algorithm referring to power and location condition.

In the third step, a transmission mobile terminal device communicates with the target mobile terminal device via the AD-HOC network for forming a non-participation mobile terminal device using the second frequency when a reception mobile terminal device wanting for communication exists in the routing table, and via the fixed communication facility using the first frequency when the reception mobile terminal device does not exist in the routing table. Here, when the transmission mobile terminal device can be connected with the reception mobile terminal device by the AD-HOC network, the second frequency communication via the AD-HOC network is not primarily used, but the first frequency communication may be used according to selection of users.

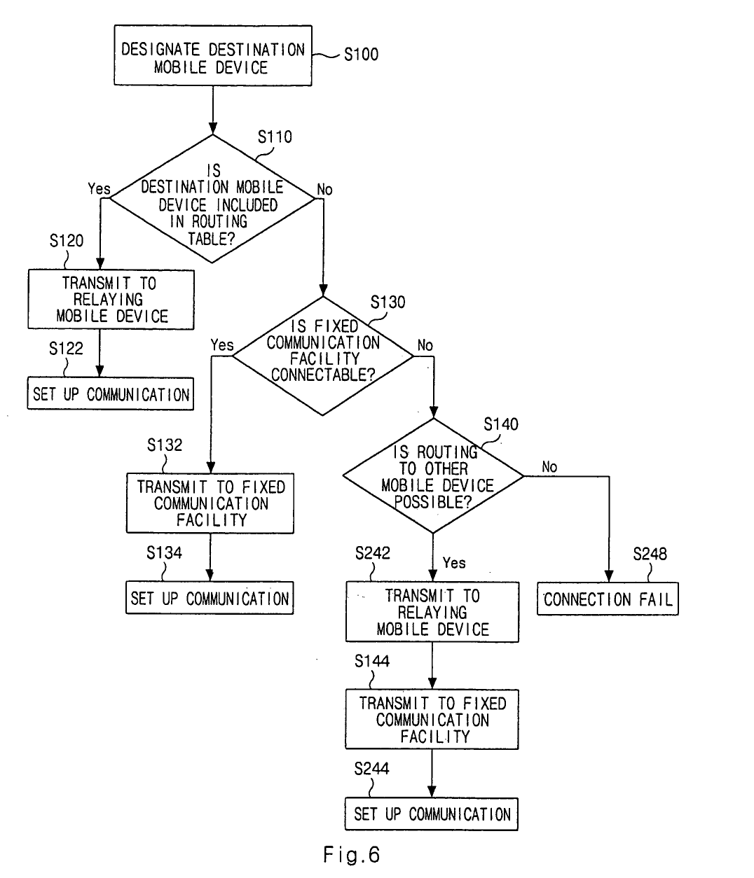

Preferably, when the transmission mobile terminal device cannot communicate with fixed communication facilities, it can communicate with fixed communication facilities by routing data into a mobile terminal device which can communicate with fixed communication facilities among mobile terminal devices formed in the AD-Hoc network. Referring to FIG. 6, if the reception mobile terminal device is designated in the transmission mobile terminal device (S100), the transmission mobile terminal device checks whether the reception mobile terminal device is included in its routing table (S110). When it is included in the routing table, a non-participation communication formed in the AD-HOC network using the second frequency communication uses a mobile terminal device as a mediating mobile terminal device (S120), and routes data from the transmission mobile terminal device into the reception mobile terminal device (S120), thereby setting communication (S122).

When the reception mobile terminal device is not included in the routing table, in order to the first frequency communication, the transmission mobile terminal device checks whether it can connect with fixed communication facilities such as base stations (S130). When the transmission mobile terminal device can connects with the fixed communication facilities, the fixed communication facilities mediate communication (S132) like a common mobile communication method, thereby setting communication between the transmission and reception mobile terminal devices (S1134).

When the transmission mobile terminal device cannot communicate with the fixed communication facilities because it is out of a range of the first frequency communication or uses a different communication system from that of fixed communication facilities, the transmission mobile terminal device judges whether there is a mobile terminal device which can communicate with fixed communication facilities among other mobile terminal devices formed in the same AD-HOC network (S140). When there is no mobile terminal device which can communicate with fixed communication facilities, the setting of communication fails, and the communication is finished (S148). When there is a mediating mobile terminal device, the transmission mobile terminal device communicates with the base station via the mediating mobile terminal device, thereby setting communication with the reception mobile terminal device (S146) through mediation of the fixed communication facilities (S144).

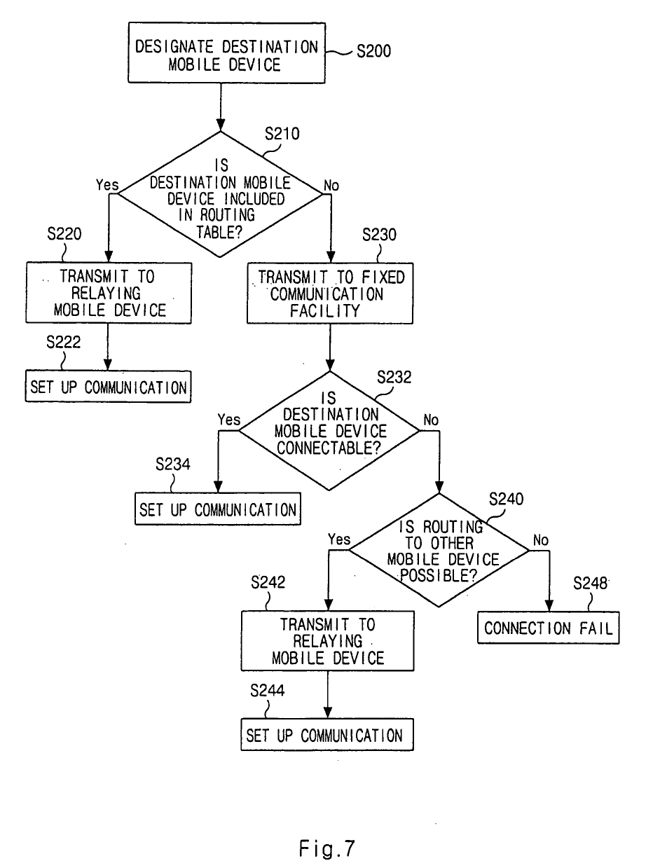

On the other hand, when the reception mobile terminal device cannot communicate with the fixed communication facilities, a mobile terminal device, which can communicate with fixed communication facilities among mobile terminal devices formed in the AD-HOC network including the reception mobile terminal device, receives data from the fixed communication facilities to route the data into the reception mobile terminal device. Referring to FIG. 7, if the reception mobile terminal device is designated in the transmission mobile terminal device (S200), the transmission mobile terminal device checks whether the reception mobile terminal device is included in its routing table (S210). When it is included in the routing table, data is routed into the reception mobile terminal device (S220) by using a participation mobile terminal device as a mediating mobile terminal device (S220) forming the AD-HOC network via the second frequency communication.

When the reception mobile terminal device is not included in the routing table, the transmission mobile terminal device is connected with the fixed communication facilities via the first frequency communication (S230). The mobile exchange station inquires a mobile terminal device location register system such as HLR, and judges whether the reception mobile terminal device is connectable via the first frequency communication (S232). When it is connectable with the fixed communication facilities, the communication between the transmission and reception mobile terminal devices is set (S234) like a common mobile communication method.

When the reception mobile terminal device is out of a range of the first frequency communication service or does not communicate with the fixed communication facility because it uses a different communication system from the fixed communication facility, the mobile terminal device judges whether there is a mediating mobile terminal device which can communicate with the fixed communication facility among other mobile terminal devices formed in the AD-HOC network including the reception mobile terminal device (S240). When there is no mobile terminal device which can communicate with the fixed communication facility, the setting of communication fails, and the communication is finished (S246). When it is proved that there is a mediating mobile terminal device, the base station communicates with the reception mobile terminal device via the mediating mobile terminal device, thereby setting communication with the reception mobile terminal device (S244) through mediation of the fixed communication facility and the mediating mobile terminal device (S242).

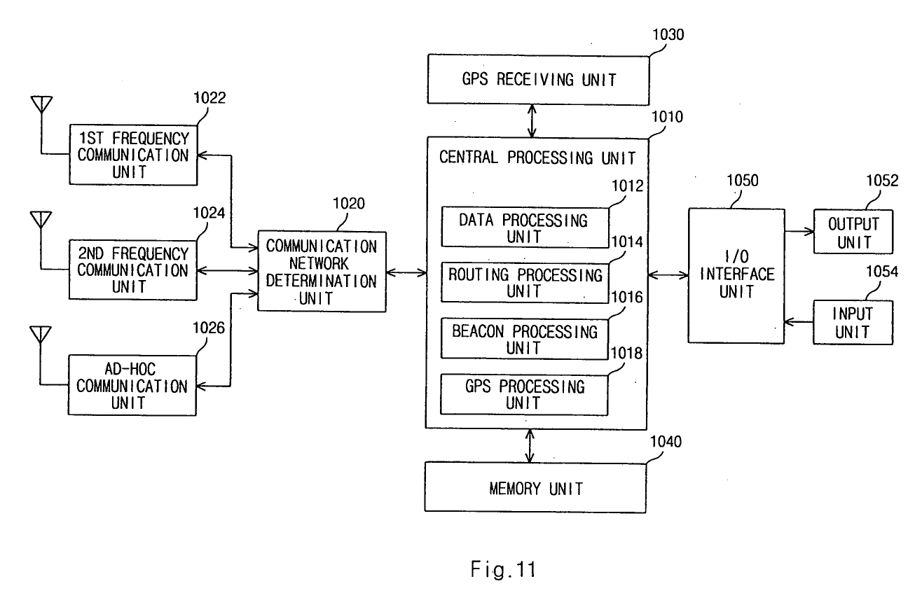

FIG. 11 is a diagram illustrating a structure of an AD-HOC combined mobile terminal device according to another preferred embodiment of the present invention. As shown in FIG. 11, the mobile terminal device according to the present invention comprises a central processing unit 1010, a communication network determination unit 1020, a plurality of communication units 1022, 1024 and 1026, a memory unit 1040, an I/O interface unit 1050, an output unit 1052 and an input unit 1054. Unlike the conventional mobile terminal device comprising one communication unit, the mobile terminal device of the present invention includes at least two or more communication units 1022 and 1024, and an AD-HOC communication unit 1026. As a result, a mobile terminal device can selectively connect with at least two or more different communication networks, and directly communicate with other mobile terminal devices formed in the AD-HOC network including a corresponding mobile terminal device.

The central processing unit 1010 converts input data from a user into a type appropriate to sound and data communication to transmit the data into the communication units 1022, 1024 and 1026, converts a sound and data packet received from the communication units into an appropriate type to be outputted to a user, and controls each component. Particularly, the central processing unit 1010 includes a beacon processing unit 1016 necessary for AD-HOC communication. The beacon processing unit 1016 detects connection nodes within other networks or other mobile terminal devices within a range of a frequency used by the AD-HOC communication unit 1016 for formation of the AD-HOC network. Each mobile terminal device having an AD-HOC communication function intermittently broadcast a beacon signal to notify information on location, residual power held in the mobile terminal device, movement rate. As a result, the ever-changing connection condition of the network can be reflected, thereby renewing the routing table of the AD-HOC network, as described before.

The beacon processing unit 1016 of the present invention can detect connection nodes of corresponding networks as well as adjacent mobile terminal devices by receiving a beacon signal broadcast from ends (hereinafter, referred to as connection node) of each communication system connected wirelessly to mobile terminal devices like base stations of cellular systems or access points of wireless LAN systems as well as a beacon signal from an adjacent mobile terminal device. Since the beacon signal is broadcast as the same frequency with the frequency allotted to common corresponding communication service, when the first frequency communication unit 1022 is connectable with a cellular system and the second frequency communication unit 1024 with a wireless LAN system, the beacon processing unit 1016 receives a beacon signal from a base station of the cellular system via the first frequency communication unit 1022, a beacon signal from a wireless access point via the second frequency communication unit 1024, and a beacon signal from an adjacent mobile terminal device via the AD-HOC communication unit 1026.

The central processing unit 1010 includes a routing processing unit 1014 for generating its routing table according to detection results of beacon signals from the beacon processing unit 1016 and routing information received from other mobile terminal devices or connection nodes, and transmitting its routing information into the other mobile terminal devices or the connection nodes at any time. Like a common AD-HOC terminal device, the mobile terminal device of the present invention including the routing processing unit 1014 renews the routing table according to variations in connection condition of the ever-changing AD-HOC network. The routing processing unit 1016 of the present invention enables a vertical hand-off between different communication systems by including information on location and connection possibility of connection nodes as well as adjacent mobile terminal devices, which can connect with a plurality of communication units comprised by corresponding mobile terminal devices, in the routing table.

Preferably, the mobile terminal device further includes the memory unit 1040, thereby storing the routing table generated from the routing processing unit 1014 of a corresponding mobile terminal device in the memory unit 1040. The memory unit 1040 stores routing information transmitted from adjacent mobile terminal devices or connection nodes.

More preferably, in relation to the routing table, routing with each mobile terminal device can consider physical location relations as well as logical location relations. Since physical location relations with adjacent mobile terminal devices or connection nodes of a corresponding mobile terminal device are closely related to the amount of power dissipation in transmission, the routing table includes location information of each mobile terminal device and connection nodes, thereby considering primarily the most adjacent mobile terminal device or connection node in selection of routing path or communication system.

Two methods for generating location information of a corresponding mobile terminal device are disclosed in the present invention. The first method is to use a GPS reception unit 1030, and the second method is to generate relative location relations by measuring the size of the beacon signal received from the adjacent mobile terminal device and the connection node. In the first method to use the GPS reception unit 1030, a corresponding mobile terminal device further includes a GPS reception unit 1030 for receiving its current location as GPS information via a GPS satellite, and a GPS processing unit 1018 for converting the GPS information into location information appropriate to communication. As a result, location information is added in a data packet transmitted via the communication units 1022, 1024 and 1026, thereby transmitting current location of the corresponding mobile terminal device into an adjacent mobile terminal device and a connection node. Additionally, the corresponding mobile terminal device extracts location information included in the data packet received from the adjacent mobile terminal device or the connection node, and then grasps location of the adjacent mobile terminal device and the connection node, thereby generating a routing table.

In the second method to use a beacon signal, the beacon processing unit 1016 measures variations in strength of beacon signals received from an adjacent mobile terminal device and a connection node using electric wave triangulation, thereby obtaining approximate location relations and movement rate of a corresponding mobile terminal device. Although an additional GPS reception is not required in this method, an absolute location relation is not found. However, when the absolute location information such as GPS information is included in a data packet received from one or more of the adjacent mobile terminal device or the connection node, the approximate location can be found, based on the information.

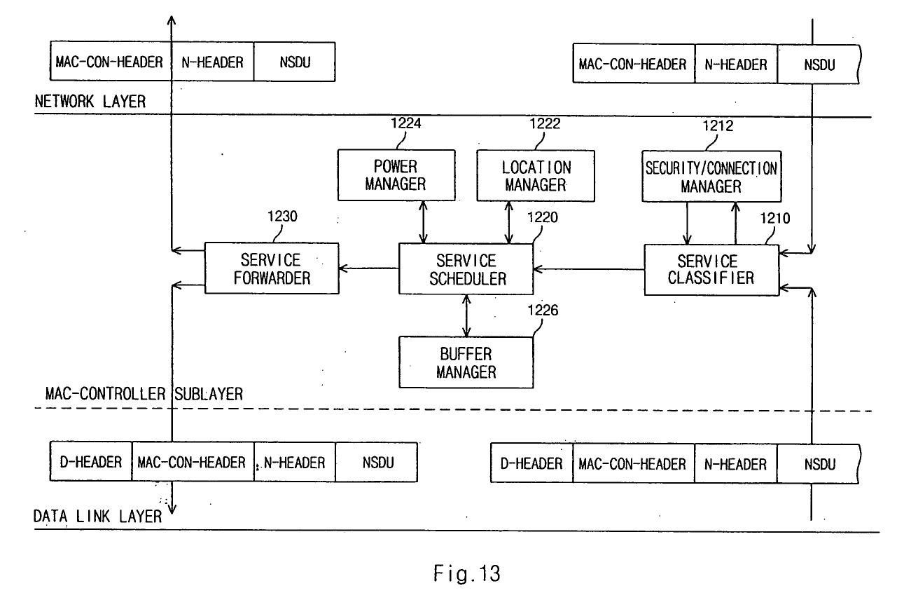

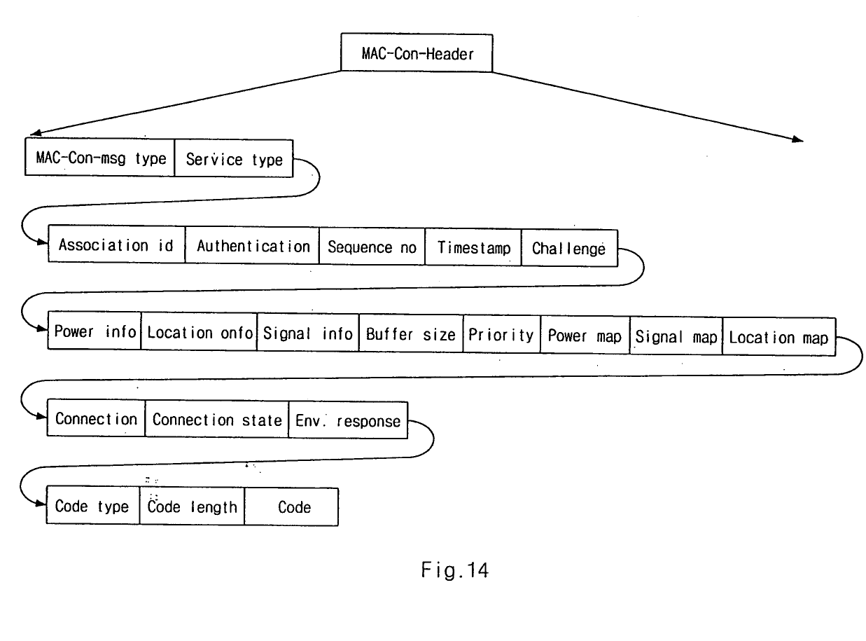

The central processing unit 1010 includes a data processing unit 1012 for generating and processing data according to an AD-HOC protocol including a routing table. Since all sound and data packets transmitted into the communication units 1022, 1024 and 1026 by the data processing unit 1012 follow the common AD-HOC protocol, even when the mobile terminal device is connected with a cellular system, the mobile terminal device can be handed off into a different network such as wireless LAN flexibly according to variation of networks or into an AD-HOC network via an adjacent mobile terminal device. The detailed explanation on the data packet according to the AD-Hoc protocol will be made referring to FIGS. 13 and 14.

The communication network determination unit 1020 determines a communication network to be used by grasping a usable network according to the routing table. Preferably, a user can designate priority among a plurality of connectable networks. For example, when a mobile terminal device can connect with a cellular system and a wireless system, the user can give priority to the wireless LAN system having low communication cost per packet. As a result, the communication network determination unit 1020 primarily determines a network to connect with the wireless system when the mobile terminal device can connect both with connection nodes (base stations) of the cellular system and connection nodes (access point) of the wireless LAN system in its current location. When it is proved that the mobile terminal device can connect with connection nodes of the wireless LAN system according to its location movement even during communication via the cellular system, the communication network determination unit 1020 controls the communication to be connect with the wireless LAN system without delay.

The communication units 1022, 1024 and 1026 can support communication with at least two or more of a plurality of different networks and AD-HOC communication with other mobile terminal devices. When the first frequency communication unit 1022 is a cellular communication module and the second frequency communication unit 1024 is a wireless communication module, if a communication module to be used by the communication network determination unit 1020 is determined, a signal processed as a base-band signal in the central processing unit 1010 is converted using a method appropriate to each communication system, and transmitted into a connection node of a corresponding communication network. Here, the sound and data packet is the same when the first frequency communication unit is used or when the second frequency communication unit is used, but it is converted into a signal appropriate to a selected network. Although each communication unit is shown to comprise a separate antenna in FIG. 11, it is preferable that the antenna is combined to support a plurality of frequency communication such as smart antenna.

In the preferred embodiment, the communication unit for supporting two different networks and the AD-HOC network is exemplified. However, the number of networks is not necessarily limited in two different networks. The number of selectable communication networks can be increased by using more than three frequency communication units. The first frequency communication unit and the second frequency communication unit can be embodied as communication modules used in different networks. Preferably, the frequency communication units can be embodied by selecting at least two or more among Bluetooth, UWB, WPAN such as wireless IEEE 1394, IEEE 802.11, WLAN such as HIPER LAN, CDMA, GSM, cellular, DVB, DAB, WCDMA, CDMA2000, LMDS, MMDS and various networks such as satellite communication.

The I/O interface unit 1050 mediates data communication between the central processing unit 1010 and the output unit 1052 for outputting the received sound and data packet to a user or the input unit 1054 for receiving the input from the user. The input unit 1054 comprises input units such as a microphone for receiving sound of the user or operation keys for receiving key inputs of the user. The output unit 1052 comprises a speaker for outputting sound and a display for outputting message and image data.

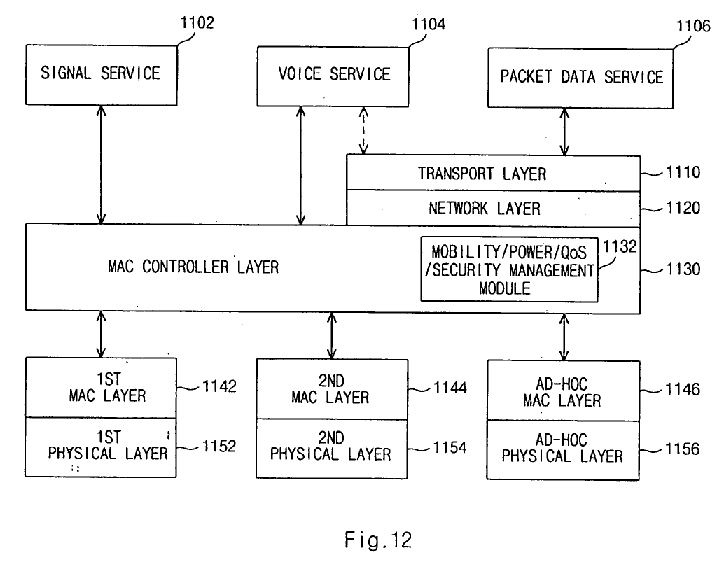

FIG. 12 is a diagram illustrating an OSI (Open system Interconnection) layer model of the mobile terminal device according to another preferred embodiment of the present invention. As shown in FIG. 12, the AD-HOC combined mobile terminal device comprises a transmission layer 1110, a network layer 1120, a data link layer (not shown), and a physical layer. However, unlike general communication equipment, the data link layer and the physical layer comprise a plurality of MAC layers 1142, 1144 and 1146, and physical layers 1152, 1154 and 1156. The plurality of MAC layers correspond to the number of frequency communication units comprised by network connectable with a signal MAC control sub-layer 1130, which is a sub-layer of the data link layer. The MAC control sub-layer 1130 includes a mobile/power/QoS (Quality of Service)/security management module 1132, thereby further including a MAC control header, which is header information related to mobility, power, service quality, connection and security, in a transmitted packet, and processing reception data according to the header information related to mobility, power, service quality, connection and security of the transmitted packet. The data packet including the MAC control header is transmitted into MAC and physical layers corresponding to a network determined by the communication network determination unit.

FIG. 13 is a flow chart illustrating a MAC control sub-layer of the AD-HOC combined mobile terminal device according to a preferred embodiment of the present invention. In a NSDU (Network Service Data Unit) top-down transmitted from network layers, service treated by a service classifier of the MAC control sub-layer is primarily classified. In general, top-down messages are registered in a security/connection manager 1212 to manage connection with data links. For this register, a security-related process such as an acknowledgement process is preceded.

Next, a corresponding sound and data packet is transmitted into a service scheduler 1220. The service scheduler 1220 receives power information, location information and buffer information of the corresponding sound and data packet from a power manager 1223, a location manager 1222 and a buffer manager 1226, and includes a header related to the above information in the sound and data packet. When a mobile terminal devices directly communicate with an adjacent mobile terminal device via the AD-HOC network, the power information means information on the amount of power dissipation between the corresponding mobile terminal device and the adjacent mobile terminal device and the current held amount of power of the corresponding mobile terminal device. The location information may be relative location information calculated by the beacon processing unit 1016 by using GPS information received from the GPS processing unit 1018 as information related to current location of the corresponding mobile terminal device or through variations in the size of the beacon signal received from the adjacent mobile terminal device. The buffer information for allotting buffers to use in transmission or reception of the sound and data packet provides a function of competing packets to transmit or receive in a plurality of communication units via a single mobile terminal device or of allotting buffers by service class for priority processing in order to satisfy quality objectives defined in quality of service QoS of a plurality of packets transmitted or received from the signal communication unit.

A service forwarding unit 1230 forwards the sound and data packet including the MAC control header into MAC and physical layers determined by the communication network determination unit 1020 among a plurality of MAC layers via the above-described process or forwards the packet to be processed in network layers which are upper layers.

FIG. 14 is a diagram illustrating the structure of the MAC control header according to the present invention. When the sound and data packet including the MAC control header is received, the service classifier 1210 filters fields on a MAC-Con-msg-type and a service type, and classifies the fields according to a corresponding message type, thereby processing the sound and data packet. The security/connection manager 1212 acknowledges and encodes messages to connect with by using fields on association id., authentication, sequence number, timestamp, challenge, connection and connection state. The service scheduler 1220 allots buffers of inputted messages and manages information on power and location by using fields on Power info., Location info., Signal info., Buffer size, Priority, Power map, Signal map, Location map and Env(environmental) response. Additionally, the service scheduler 1220 includes a control and management function for supporting the optimum network use by including program codes such as code type, code length and code performed in a mobile terminal device receiving a corresponding packet as well as data representing simple control information in a packet, and performing a program included in a self-packet according to network conditions.

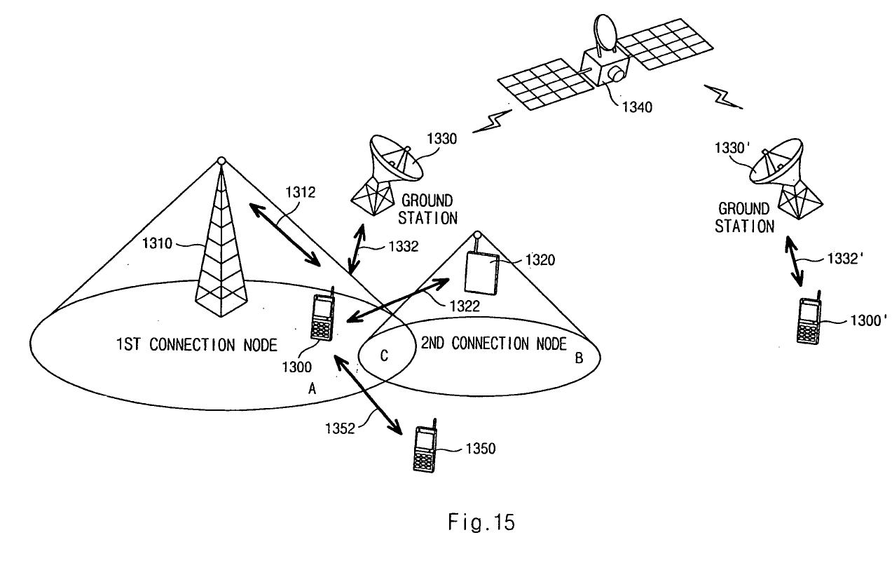

FIG. 15 is a diagram illustrating an AD-HOC combined multi-mobile communication system according to a preferred embodiment of the present invention. The mobile communication system comprises a plurality of communication networks and a plurality of mobile terminal devices 1300, 1350 and 1300′. Each communication network connects (1312, 1322) with the mobile terminal device 1330 via connection node 1310 and 1320, mediates sound and data communication of the mobile terminal device 1300, and routes sound and data according to an AD-HOC protocol. For example, when the mobile terminal device 1300 can connect with a cellular network and a wireless LAN network, the connection nodes are the base station 1310 of the cellular network and the access point 1320 of the wireless LAN network. However, since sound and data of the present invention transmitted and received between the mobile terminal device 1300 and the connection nodes 1310 and 1320 are routed according to the AD-HOC protocol unlike the conventional communication system, the data includes power information, location information and buffer information by further including the MAC control header.

The mobile terminal device 1300 can transmit and receive sound and data by directly connecting with other mobile terminal devices 1350 and at least two or more of connection nodes 1310 and 1320 of each communication network. The mobile terminal device is selectively connected with one of the connection nodes 1310 and 1320 of the network or other mobile terminal devices 1350 according to a communication protocol corresponding to each network during communication dependent on communication conditions. Additionally, the mobile terminal device renews a routing table related to the other mobile terminal device 1350 or the connection nodes 1310 and 1320 connectable at any time according to the AD-HOC protocol to broadcast the outing table into the connection nodes and the other mobile terminal device. That is, the mobile terminal device 1300 includes a data link header adapted to a corresponding communication network through a MAC layer corresponding to a selected network as well as a MAC control header according to the AD-Hoc protocol through a MAC control sub-layer, thereby transmitting data according to a modulating and demodulating system and a frequency defined in a corresponding network through a physical layer corresponding to a selected network.

When the connected mobile terminal device 1300 is connected from the first communication network to the second communication network in a plurality of networks, the first communication network routes a sound and data communication of the mobile terminal device 1300 into the second communication network. When the mobile terminal device 1300 moves from the area A to the area B of FIG. 5, it is connected with the first communication network in the area A (1312), and with the second communication network in the area B (1322).

Preferably, the mobile terminal device 1300 further including a GPS reception unit broadcasts routing information further including its location information. When the sound and data is routed into the mobile terminal device 1300, the communication networks can transmit data through the most adjacent connection nodes 1310 and 1320 to location information of the mobile terminal device into the mobile terminal device 1300 or the other mobile terminal device 1350 formed in the AD-HOC network 1352 including the mobile terminal device 1300, as described before.

According to another preferred embodiment of the present invention, the mobile terminal device 1300 connects with a satellite communication network, thereby extending its communicatable range. A low earth orbit satellite or a middle earth orbit satellite can communicate with a portable mobile terminal device on earth. However, for communication with a geostationary orbit satellite, the distance between a satellite and a wireless mobile terminal device increases. As a result, a high output is required, thereby causing limits in actual design of the mobile terminal device. Accordingly, the communication of a ground station 1330 and the AD-HOC communication is more preferably used than the direct communication with the satellite 1340. For example, when a WLAN system is used for a means of the AD-HOC communication, the mobile terminal device 1300 should be connected with a WLAN communication network. The ground station 1330 communicates with a WLAN connection node via an ethernet port. As a result, the mobile terminal device 1300 can communicate with the ground station 1330, thereby directly communicating with the mobile terminal device 1300′ via the ground station 1330′ located in a remote place through the satellite 1340.

When the mobile terminal device 1300 communicates with the ground station 1330 (1332) using the AD-HOC network, a MAC control sub-layer according to the AD-HOC communication is further included in the ground station. As a result, the AD-HOC network is formed with the mobile terminal device 1300, thereby enabling communication.

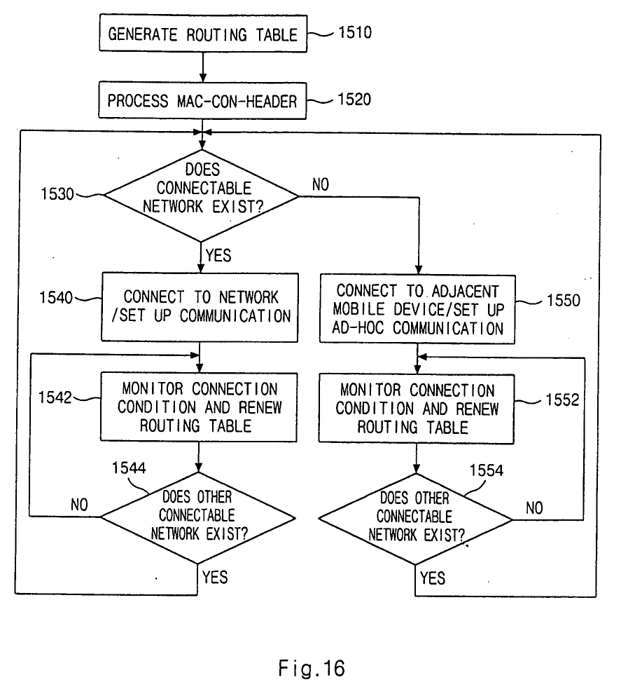

FIG. 16 is a flow chart illustrating a communication method of an AD-HOC combined mobile terminal device according to another preferred embodiment of the present invention. In the first step, the mobile terminal device detects a connectable network and an adjacent mobile terminal device to generate a routing table and determine a network to be connected (1510). The detection of a network and a mobile terminal device is performed by receiving a beacon signal from the connection nodes 1310 and 1320 of the network and the adjacent mobile terminal device 1350.

In the second step, a MAC-control header according to an AD-HOC protocol is added in a sound and data packet to be transmitted (1520). The MAC control header enhances efficiency of routing by including power information, location information and buffer information.

Next, the mobile terminal device connects with a corresponding communication network via a physical layer connectable with the network determined in the first step (1540). When there is no connectable network, in the third step, the mobile terminal device connects with the other mobile terminal device via an AD-HOC physical layer directly connectable with other adjacent mobile terminal device (1350) (1550).

In the fourth step, the mobile terminal device continuously monitors connection condition with the network connected in the third step or other mobile terminal devices (1542), and renewing a routing table (1552). The detection of connection conditions is performed using a method similar to the conventional mobile communication. The renewal of the routing table prepares variations of networks resulting from location and power changes of the corresponding mobile terminal device 1300 and the adjacent mobile terminal device 1350.

In the fifth step, the mobile terminal device connects other networks or other mobile terminal devices except the currently connected network or other mobile terminal network when the connection condition is proved to be inferior (1544, 1554).

More preferably, the first step further comprises the sub-step of inputting priority into a plurality of networks with which the mobile terminal device can connect, wherein when a plurality of connectable networks are competing in network determination of the first step and network change of the fifth step, a network is determined or changed according to the priority. For example, referring to FIGS. 4 and 11, the mobile terminal device is located in the area C connectable with the first network and the second network both, a user can set communication so that the mobile terminal device may primarily communicate with the network which the user inputs priority.

### INDUSTRIAL APPLICABILITY

As discussed earlier, according to the AD-HOC network combined communication system, the communication apparatus and the communication method of the present invention, when the transmission and reception mobile terminal devices form the same AD-HOC network, the remarkably economical and stable mobile communication can be performed via mediating mobile terminal devices without using fixed communication facilities. Here, the conventional wireless mobile communication can be used. According to a preferred embodiment of the present invention, when the transmission mobile terminal device or the reception mobile terminal device exists in the service limit area such as an electric wave shadow area or uses different communication system from the fixed communication facilities, the mobile terminal device can communicate with other mobile terminal devices by using the fixed communication facilities via the AD-HOC network. According to another preferred embodiment of the present invention, when the mobile terminal device communicates with other mobile terminal devices by using the AD-HOC network, the distributed control communication mode and the centralized control communication mode can be used flexibly according to communication conditions, thereby enabling the effective use of channels.

In addition, according to a preferred embodiment of the present invention, the vertical hand-off between different wireless mobile communication networks is possible by performing communication using the common AD-HOC protocol. According to a preferred embodiment of the present invention, there is provided the mobile terminal device which can connect with a satellite ground station for communication with a satellite or VSAT, a micro bidirectional satellite terminal device, the wireless mobile communication system, and the mobile communication method. According to another preferred embodiment of the present invention, there is provided the communication system wherein data can be effectively routed between different mobile communication networks by extracting precise location information of a mobile terminal device from a GPS communication signal or a beacon signal received from an adjacent mobile terminal device.

The preferred embodiments of the present inventions have been shown by way of example. The invention covers all modifications, equivalents, and alternatives falling within the spirit and scope of the invention as defined in the appended claims.

What is claimed is:

1. An AD-HOC combined mobile communication system configured to include a transmission mobile terminal device, a reception mobile terminal device and other non-participation mobile terminal devices and a fixed communication facility for controlling communication between mobile terminal devices and for mediating communication between the transmission mobile terminal device and the reception mobile terminal device,
wherein an AD-HOC network is formed between the mobile terminal devices, each device including a second frequency communication means for direct communication;
wherein the transmission mobile terminal device can communicate with the reception mobile terminal device via the AD-HOC network when the AD-HOC network is formed between the transmission mobile terminal device, the reception mobile terminal device and other non-participation mobile terminal devices via the second frequency communication means for intercommunication.

2. The system according to claim 1, wherein when the transmission mobile terminal device and the reception mobile terminal device are included in a first AD-HOC network and a second AD-HOC network, respectively, the first AD-HOC network is connected to the second AD-HOC network via the fixed communication facility.

3. The system according to claim 1 or 2, wherein a licensed or unlicensed frequency is used for the second frequency.

4. The system according to claim 1 or 2, wherein when the transmission mobile terminal device and the reception mobile terminal device, respectively, use a first fixed communication facility and a second fixed communication facility using different communication methods, and the reception mobile terminal device is not included in the AD-HOC network including the transmission mobile terminal device, the transmission mobile terminal device is connected with a non-participation mobile terminal using the second fixed communication facility connected to the AD-HOC network via the second frequency communication, the non-participation mobile terminal connected with the reception mobile terminal device via the second fixed communication facility.

5. The system according to claim 1 or 2, wherein when the transmission mobile terminal device and the reception mobile terminal device, respectively, use a first fixed communication facility and a second fixed communication facility using different communication methods, and the reception mobile terminal device is not included in the AD-HOC network including the transmission mobile terminal device, the transmission mobile terminal device is connected with a non-participation mobile terminal using the first fixed communication facility and forming the AD-HOC network including the reception mobile terminal device via a first fixed communication facility, the non-participation mobile terminal connected with the reception mobile terminal device via the AD-HOC network.

6. The system according to claim 4, wherein when the transmission mobile terminal device and the reception mobile terminal device, respectively, use a first fixed communication facility and a second fixed communication facility using different communication methods, and the reception mobile terminal device is not included in the AD-HOC network including the transmission mobile terminal device, the transmission mobile terminal device is connected with a non-participation mobile terminal using the first fixed communication facility and forming the AD-HOC network including the reception mobile terminal device via a first fixed communication facility, the non-participation mobile terminal connected with the reception mobile terminal device via the AD-HOC network.

7. The system according to claim 1 or 2, wherein the mobile terminal device periodically generates a beacon signal with a second frequency and receives the beacon signal as a acknowledgement signal to recognize other mobile terminal device within a range of the second frequency.

8. The system according to claim 7, wherein the mobile terminal device generates a routing table to the recognized mobile terminal device and transmits its routing information into other mobile terminal device within a range of the second frequency.

9. The system according to claim 8, wherein the routing table includes a mobile terminal device identifier to other mobile terminal device, the number of hop, the amount of power dissipation and location information.

10. The system according to claim 9, wherein the mobile terminal device identifier is more than two mapping information among an electronic serial number given to the mobile terminal device, a MAC address, an IPv4 address and an IPv6 address.

11. The system according to claim 1 or 2, wherein each mobile terminal device checks communication condition information including individual information on traffic, the competitive rate for channel occupation and the number of adjacent mobile terminal devices within a range of the second frequency at any time;
wherein each mobile terminal device communicates via a centralized control communication mode when one of the individual information is proved to be more than set value, and via a distributed control communication mode when all of individual information proved to be less than set value.

12. The system according to claim 11, wherein the distributed control communication mode is one of ALOHA or CSMA, and the centralized control communication mode is one of slotted ALOHA, reservation ALOHA, PRMA, TDMA, reservation TDMA, polling and ISMA.

13. The system according to claim 11, wherein at least one reference mobile terminal device is selected for controlling communication slot assignment among mobile terminal devices in the same AD-HOC network when each mobile terminal device communicates via the centralized control communication mode.

14. The system according to claim 13, wherein the reference mobile terminal device is selected from the group consisting of a mobile terminal device having the best power condition, a mobile terminal device having little variation in location and a mobile terminal device including the most mobile terminal devices within a range of the second frequency.

15. An AD-HOC combined mobile communication device configured to be controlled by a fixed communication facility and communicate with other mobile terminal device via the fixed communication facility, comprising:
a first frequency communication means for communication via the fixed communication facility;
a second frequency communication means for transmitting and receiving data, a beacon signal and routing information into other mobile terminal devices via an AD-HOC network; and
a processor for controlling the communication device,
wherein the processor includes:
a beacon processing unit for detecting other mobile terminal device within a range of the second frequency for formation of the AD-HOC network;
a routing processing unit for generating its routing table dependent on detection results from the beacon processing unit and routing information received from other mobile terminal devices; and
a communication processing unit for activating the second frequency communication means when other mobile terminal devices for communication are included in the routing table, and for activating the first frequency communication means when they are not included in the routing table.

16. The device according to claim 15, wherein a licensed or unlicensed frequency is used for the second frequency.

17. The device according to claim 15 or 16, wherein when the mobile terminal devices cannot communicate with the fixed communication facility via the first frequency communication means, the communication processing unit routes data via the second frequency communication means using other mobile terminal devices which can communicate with the fixed communication facility in the routing table, and then transmits data including routing control information for communication with a target mobile terminal device via the fixed communication facility.

18. The device according to claim 15 or 16, wherein the beacon processing unit periodically broadcasts a beacon signal via the second frequency communication means, and receives a acknowledgement signal of other mobile terminal device in response to the beacon signal to transmit the acknowledgement signal into the routing processing unit.

19. The device according to claim 18, wherein the routing processing unit generates a routing table by collecting the acknowledgement signal received from the beacon processing unit and routing information received from other mobile terminal device.

20. The device according to claim 19, wherein the routing table includes a mobile terminal device identifier to other mobile terminal device, the number of hop, the amount of power dissipation and location information.

21. The device according to claim 20, wherein the mobile terminal device identifier is more than two mapping information among an electronic serial number given to the mobile terminal device, a MAC address, an IPv4 address and an IPv6 address.

22. The device according to claim 15 or 16, wherein the communication processing unit checks communication condition information including individual information on traffic, the competitive rate for channel occupation and the number of adjacent mobile terminal devices within a range of the second frequency at any time;
wherein the communication processing unit enables mobile terminal devices to communicate via a centralized control communication mode when one of the individual information is proved to be more than set value, and via a distributed control communication mode when all of the individual information proved to be less than set value.

23. The device according to claim 22, wherein the distributed control communication mode is one of ALOHA or CSMA; and
the centralized control communication mode is one of slotted ALOHA, reservation ALOHA, PRMA, TDMA, reservation TDMA, polling and ISMA.

24. An AD-HOC combined mobile communication method for performing communication between mobile terminal devices controlled by a fixed communication facility via a first frequency, comprising:
a first step wherein the mobile terminal device grasps other mobile terminal devices within a range of a second frequency;
a second step wherein routing information is consecutively exchanged between the mobile terminal devices to generate a routing table, thereby forming an AD-HOC network; and
a third step wherein a transmission mobile terminal device communicates with the target mobile terminal device via the AD-HOC network for forming a non-participation mobile terminal device using the second frequency when a reception mobile terminal device wanting for communication exists in the routing table, and via the fixed communication facility using the first frequency when the reception mobile terminal device does not exist in the routing table.

25. The method according to claim 24, wherein the second frequency is a licensed or unlicensed frequency.

26. The method according to claim 24 or 25, wherein in the third step, the transmission mobile terminal device communicates with the fixed communication facility by routing data into other mobile terminal device which can communicate with the fixed communication facility among mobile terminal devices in the AD-HOC network including the transmission mobile terminal device when the transmission mobile terminal device cannot communicate with the fixed communication facility.

27. The method according to claim 24 or 25, wherein in the third step, the reception mobile terminal device, which can communicate with the fixed communication facility among mobile terminal devices in the AD-HOC network including the reception mobile terminal device, receives data from the fixed communication facility to route the data into the reception mobile terminal device when the reception mobile terminal device cannot communicate with the fixed communication facility.

28. The method according to claim 26, wherein in the third step, the reception mobile terminal device, which can communicate with the fixed communication facility among mobile terminal devices in the AD-HOC network including the reception mobile terminal device, receives data from the fixed communication facility to route the data into the reception mobile terminal device when the reception mobile terminal device cannot communicate with the fixed communication facility.

29. The method according to claim 24 or 25, wherein the routing table includes a mobile terminal device identifier to other mobile terminal device, the number of hop, the amount of power dissipation and location information.

30. The method according to claim 29, wherein the mobile terminal device identifier is more than two mapping information among an electronic serial number given to the mobile terminal device, a MAC address, an IPv4 address and an IPv6 address.

31. The method according to claim 24 or 25, wherein in the third step, when each mobile terminal device communicates via the AD-HOC network,
each mobile terminal device checks communication condition information including individual information on traffic, the competitive rate for channel occupation and the number of adjacent mobile terminal devices within a range of the second frequency at any time;
wherein each mobile terminal device communicates via a centralized control communication mode when one of the individual information is proved to be more than set value, and via a distributed control communication mode when all of the individual information proved to be less than set value.

32. The method according to claim 31, wherein the distributed control communication mode one of ALOHA or CSMA, and the centralized control communication mode is one of slotted ALOHA, reservation ALOHA, PRMA, TDMA, reservation TDMA, polling and ISMA.

33. The method according to claim 31, wherein the at least one reference mobile terminal device is selected for controlling communication slot assignment among mobile terminal devices in the same AD-HOC network when each mobile terminal device communicates via the centralized control communication mode.

34. The method according to claim 33, wherein the reference mobile terminal device is selected from the group consisting of a mobile terminal device having the best power condition, a mobile terminal device having little variation in location and a mobile terminal device including the most mobile terminal devices within a range of the second frequency.

35. An AD-HOC combined mobile terminal device configured to connect selectively with at least two or more of a plurality of communication networks and communicate with other mobile terminal device via the communication network, comprising:
a beacon processing unit for detecting other mobile terminal device within a range of the second frequency for formation of the AD-HOC network;
a routing processing unit for generating its routing table dependent on detection results from the beacon processing unit and routing information received from other mobile terminal devices or connection nodes to transmit the routing table into the other mobile terminal devices or the connection nodes at any time;
a data processing unit for generating and processing data dependent on an AD-HOC protocol including the routing information;
a communication network determining unit for grasping a usable network dependent on the routing table and determining a network to be used; and
a communication unit for supporting communication with at least two or more of a plurality of different networks and AD-HOC communication with other mobile terminal devices.

36. The device according to claim 35, wherein the plurality of networks are at lest two or more selected from the group consisting of WPAN (Bluetooth, UWB, Wireless IEEE 1394), WLAN (IEEE 802.11, HIPER LAN), CDMA, GSM, Cellular, DVB, DAB, WCDMA, CDMA2000, LMDS, MMDS and satellite communication.

37. The device according to claim 35, wherein the mobile terminal device further comprises a GPS reception unit for receiving location information of a current mobile terminal device via a GPS satellite; and the routing processing unit further comprises location information received from the GPS reception unit to generate its routing table.

38. The device according to claim 35 or 37, wherein the communication network determining unit continuously communicates via connection nodes of other connectable networks or via other mobile terminal devices which can connect with connection nodes other networks.

39. The device claim 35 or 37, wherein the data processing unit comprises:
a service classifying means for including security information and connection information in the data; and
a service determining means for including power information, location information, buffer information and control and management program performed in a corresponding wireless mobile communication terminal device.

40. The device according to claim 39, wherein the power information includes information on the amount of electric power used for communication with adjacent mobile terminal devices and on the current holding amount of electric power; and
the location information is relative GPS information or location information calculated from a beacon signal received from adjacent mobile terminal devices.

41. The device according to claim 35 or 37, further comprising a satellite communication unit for directly connecting with the mobile terminal device and the satellite.

42. An AD-HOC combined mobile terminal device including a plurality of data link layers and physical layers which are connectable with two or more networks respectively, comprising a MAC control sub-layer for selecting one of the plurality of data link layers and physical layers, including a MAC control header dependent on an AD-HOC communication protocol in a communication packet transmitted from an upper layer, and mediating sound and data packets received according to the AD-HOC protocol from other mobile terminal devices.

43. The device according to claim 42, wherein the MAC control header includes connection and certification information, power information, location information, buffer information, and control and management programs performed in corresponding wireless mobile communication terminal devices.

44. The device according to claim 43, wherein the mobile terminal device further comprises a GPS reception unit, and
the location information is generated by GPS location information received from the GPS reception unit.

45. The device according to claim 43, wherein the mobile terminal device further comprises a beacon processing unit for calculating relative location information according to size of a beacon signal received from an adjacent mobile terminal device, and
the location information is generated by relative location information calculated from the beacon processing unit.

46. An AD-HOC combined mobile communication system, comprising:
at least two or more of a plurality of networks for connecting with mobile terminal devices via connection nodes, mediating sound and data communication of mobile terminal devices and routing data according to an AD-HOC protocol; and
a mobile terminal device for directly connecting with connection nodes of at least two or more of the networks and other mobile terminal devices to transmit or receive sound or data, selectively connecting with other mobile terminal devices or one of connection nodes of the networks according to communication protocols corresponding to each network during communication dependent on communication condition, and broadcasting its routing information to other mobile terminal devices and the connection nodes by updating a routing table related to other mobile terminal devices or the connection nodes connected at any time according to the AD-HOC protocol,
wherein when the connected mobile terminal device connects with a second network from a first network currently communicated of the plurality of networks, the first network routes the sound and data communication of the mobile terminal device into the second network.

47. The system according to claim 43, wherein the mobile terminal device further comprises a GPS reception unit to broadcast data by further including its location information in the routing table,
wherein when the network routes data into the mobile terminal device, the network transmits the sound and data into the mobile terminal device or other mobile terminal devices formed in the AD-HOC network including the mobile terminal device via the most adjacent connection node to location information of the mobile terminal device.

48. The system according to claim 46 or 47, wherein the AD-HOC combined multi-wireless mobile communication system further comprises a satellite for mediating a sound and data signal and a satellite communication network including a ground station for transmitting and receiving sound and data with the satellite,
Wherein the ground station can communicate with the mobile terminal device.

49. The system according to claim 48, wherein the mobile terminal device can connect with a WLAN network,
wherein the ground station communicates with a WLAN connection node via an Ethernet port.

50. The system according to claim 49, wherein the ground station forms an AD-HOC network with the mobile terminal device.

51. An AD-HOC combined mobile communication method, comprising:
a first step of detecting a connectable network and an adjacent mobile terminal device to generate a routing table and determine a network to be connected;
a second step of adding a MAC-control header according to an AD-HOC protocol in a sound and data packet to be transmitted;
a third step of connecting with the network via a physical layer connectable with the network determined in the first step, and connecting with other mobile terminal devices directly connectable with other adjacent mobile terminal devices when a mobile terminal device does not have a connectable network;
a fourth step of continuously monitoring connection condition with the network connected in the third step or other mobile terminal devices, and renewing a routing table; and
a fifth step of connecting other networks or other mobile terminal devices except the currently connected network or other mobile terminal network when the connection condition is proved to be inferior.

52. The method according to claim 51, wherein the first step further includes the sub-step of inputting priority into a plurality of networks with which the mobile terminal device can connect,
wherein when a plurality of connectable networks are competing in network determination of the first step and network change of the fifth step, a network is determined or changed according to the priority.

53. The method according to claim 51 or 52, wherein the MAC control header of the second step includes connection and certification information, power information, location information, buffer information, and control and management programs performed in corresponding wireless mobile communication terminal devices.

54. The method according to claim 53, wherein the first step further includes the sub-step of receiving location information of a current mobile terminal device via a GPS satellite.

55. The method according to claim 53, wherein the first step further includes the sub-step of calculating location information via relative variation in size of a beacon signal received from an adjacent mobile terminal device.
